(19) United States
(12) Patent Application Publication
(10) Pub. No.: US 2024/0205991 A1
(43) Pub. Date: Jun. 20, 2024

(54) NEIGHBOR AWARE NETWORKING COMMUNICATION WITH MULTI-NAN DATA LINK OPERATION

(71) Applicant: QUALCOMM Incorporated, San Diego, CA (US)

(72) Inventors: Imran Ansari, Hyderabad (IN); Rajeev Kumar Singh, Hyderabad (IN); Harbeer Singh, Hyderabad (IN); Prashant Harkude, Hyderabad (IN); Shaikh Asfaquz Zaman, Hyderabad (IN)

(21) Appl. No.: 18/069,186

(22) Filed: Dec. 20, 2022

(51) Int. Cl. H04W 76/15; H04W 8/00

(52) U.S. Cl. CPC H04W 76/15; H04W 8/005

(57) ABSTRACT

This disclosure provides methods, components, devices and systems for Neighbor Aware Networking (NAN) communications between two devices concurrently over multiple NAN Data Links (NDLs). A multi-NDL connection is formed between two NAN devices where both devices support multi-link operation (MLO) for NAN communications. A first NAN device and a second NAN device each advertises its respective capability to support MLO for NAN communications to the other device by transmitting to the other device a NAN frame that includes an MLO information element. A multi-NDL connection is formed between the first NAN device and the second NAN device in accordance with the information in the multi-link information elements. Each NDL of the multi-NDL connection is associated with a set of frequency channels that do not overlap the set of frequency channels associated with another NDL. Concurrent NAN communication can occur over the multiple NDLs.

### TECHNICAL FIELD

This disclosure relates generally to wireless communication, and more specifically, to Neighbor Aware Networking (NAN) communication over multiple NAN Data Links (NDLs).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A WLAN network may support Neighbor Aware Networking (NAN), also known as Wi-Fi Aware Networking. The NAN protocol is defined by the Wi-Fi Alliance (WFA) Neighbor Aware Networking standard specification. A NAN Data Link (NDL) network is a network of NAN devices that typically supports one or more services or applications, such as video or audio streaming, that is of interest to devices within the NDL network. Participant NAN devices in an NDL network receive services by associating with other NAN devices in the network. NAN devices may advertise the services that they can provide and may discover services advertised by nearby NAN devices. NDL networks do not typically depend on a network infrastructure, such as one or more access points (APs), or Wi-Fi direct group formation, to access services. Additionally, in some scenarios or instances, NAN devices may not use, or at least not rely on, a Global Positioning System (GPS), cellular data, or Internet.

### SUMMARY

The systems, methods and devices of this disclosure each have several innovative aspects, no single one of which is solely responsible for the desirable attributes disclosed herein.

One innovative aspect of the subject matter described in this disclosure can be implemented in a Neighbor Aware Networking (NAN) device. The NAN device includes at least one memory. The NAN device includes at least one processor communicatively coupled with the at least one memory and operable to cause the NAN device to transmit a first NAN frame to a second NAN device. The first NAN frame includes a first multi-link operation (MLO) information element indicating a capability of the NAN device for concurrent multi-NAN Data Link (NDL) NAN operation. The at least one processor communicatively coupled with the at least one memory is operable to cause the NAN device to receive a second NAN frame from the second NAN device. The second NAN frame includes a second MLO information element indicating a capability of the second NAN device for concurrent multi-NDL NAN operation. The at least one processor communicatively coupled with the at least one memory is operable to establish, in accordance with the first indication and the second indication, a multi-NDL NAN connection with the second NAN device. The multi-NDL NAN connection includes a first NDL associated with a first set of frequency channels and a second NDL associated with a second set of frequency channels non-overlapping the first set of frequency channels. The at least one processor communicatively coupled with the at least one memory is further operable to communicate with the second NAN device via the first NDL and the second NDL. At least part of the communication is concurrent via the first NDL and the second NDL.

Another innovative aspect of the subject matter described in this disclosure can be implemented in a method for wireless communication by a NAN device. The method includes transmitting a first NAN frame to a second NAN device. The first NAN frame includes a first MLO information element indicating a capability of the NAN device for simultaneous multi-NDL NAN operation. The method includes receiving, from the second NAN device, a second NAN frame that carries a second MLO information element indicating a capability of the second NAN device for simultaneous multi-NDL NAN operation. The method includes establishing, in accordance with the first indication and the second indication, a multi-NDL NAN connection with the second NAN device. The multi-NDL NAN connection includes a first NDL associated with a first set of frequency channels and a second NDL associated with a second set of frequency channels non-overlapping the first set of frequency channels. The method includes communicating with the second NAN device via the first NDL and the second NDL at least partially concurrently.

In an innovative aspect, the method for wireless communication by the NAN device includes receiving, from the second NAN device, a request message that includes a second multi-link device (MLD) MAC address associated with the second NAN device. The method includes transmitting, to the second NAN device, a response message that includes a first MLD MAC address associated with the NAN device. The method includes receiving, from the second NAN device, a confirmation message indicating at least a respective discovery window associated with each of the first NDL and the second NDL.

Another innovative aspect of the subject matter described in this disclosure can be implemented in a NAN device. The NAN device includes means for transmitting a first NAN frame to a second NAN device. The first NAN frame includes a first MLO information element indicating a capability of the NAN device for simultaneous multi-NDL NAN operation. The NAN device includes means for receiving a second NAN frame from the second NAN device. The second NAN frame includes a second MLO information element indicating of a capability of the second NAN device for simultaneous multi-NDL NAN operation. The NAN device includes means for establishing, in accordance with the first indication and the second indication, a multi-NDL NAN connection with the second NAN device. The multi-NDL NAN connection includes a first NDL associated with a first set of frequency channels and a second NDL associated with a second set of frequency channels non-overlapping the first set of frequency channels. The NAN device includes means for communicating with the second NAN device via the first NDL and the second NDL at least partially concurrently.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows example Neighbor Aware Networking (NAN) communications between two NAN devices.

FIG. 4 shows a NAN Data Link (NDL) between a first NAN device and a second NAN device.

FIG. 5 shows an example NAN frame usable for communications between NAN devices, according to some aspects.

FIG. 6 shows a Device Capability information element of an example NAN frame.

FIG. 7 shows a Multi-link Operation (MLO) information element of an example NAN frame, according to some aspects.

FIG. 8 shows a sequence diagram depicting NAN communications for setting up a multi-NDL connection, according to some aspects.

FIG. 9 shows an MLO information element of an example request message, according to some aspects.

FIG. 10 shows example NAN communications including a request frame, a response frame, and data frames, according to some aspects.

FIG. 11 shows a flowchart illustrating an example process for forming a multi-NDL connection and communicating at least partially concurrently over the multiple NDLs, according to some aspects.

FIG. 12 shows a flowchart illustrating an example process for forming a multi-NDL connection, according to some aspects.

FIG. 13 shows an example multi-NDL connection between a first NAN device and a second NAN device, according to some aspects.

FIG. 14 shows a flowchart illustrating an example process performable at a wireless station that supports MLO for NAN communications, according to some aspects.

FIG. 15 shows a block diagram of an example wireless communication device that supports MLO for NAN communications, according to some aspects.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

The current Wi-Fi Alliance (WFA) Neighbor Aware Networking (NAN) standard specification provides for communication among two or more NAN-compliant devices (hereinafter also referred to as “NAN devices”) over a NAN Data Link (NDL). Each NAN device of the NDL may include one or more NAN Data Interfaces (NDIs). The NDL may include multiple NAN Data Paths (NDPs), each of which may be a respective data connection between an NDI of a respective transmitting NAN device and an NDI of a respective receiving NAN device. In existing schemes, each NDP of the NDL is associated with the same frequency channel or set of frequency channels as all the other NDPs of the NDL. As such, even where the NDL includes multiple NDPs, only one NDP is usable for data communication at one time. Existing schemes also do not provide for communication between two NAN devices over more than one NDL concurrently. Consequently, under the existing schemes, NAN communications among NAN devices within a network occur over only one frequency channel or set of frequency channels at a time.

Various aspects relate generally to NAN communication with multi-link operation (MLO). Some aspects more specifically relate to transmission and/or reception of NAN communications between two NAN devices over two (or more) NDLs at least partially concurrently. In some examples, the NAN devices support MLO as defined for Extremely High Throughput (EHT) operation in IEEE 802.11be or defined for operation in a subsequent generation of the IEEE 802.11 family of wireless communication protocol standards. In some examples, a NAN device that supports MLO for NAN communications may autonomously advertise its capability to support MLO for NAN communications to other NAN devices. In some such examples, another NAN device that receives this advertisement and that also supports MLO for NAN communications may respond by advertising its capability to support MLO for NAN communications. In some aspects, each NAN device may advertise its capability to support MLO for NAN communications to other NAN devices by transmitting a NAN frame that includes an MLO information element (IE). The MLO IE may specifically indicate a capability of the NAN device for simultaneous multi-NDL operation; that is, a capability to communicate concurrently over two or more NDLs. In some examples, a multi-NDL connection is established between NAN devices after they exchange NAN frames that include such an MLO IE. In some aspects, each NDL of the multi-NDL connection may be formed such that communications via the NDL occur over a respective set of frequency channels that do not overlap any other set of frequency channels associated with any other of the NDLs.

Particular aspects of the subject matter described in this disclosure can be implemented to realize one or more of the following potential advantages. In some examples, establishment of a multi-NDL connection between NAN devices that are also MLO-capable, enables NAN devices to communicate with each other over two or more NDLs at least partially concurrently, which may enable increased throughput (relative to using a single NDL or relative to using two NDPs that are each associated with the same frequency channel or set of channels), decreased latency, and/or reduced power consumption. These benefits may enhance user experience when using NAN, and may be especially beneficial when transmitting data associated with augmented reality (AR) and virtual reality (VR) applications.

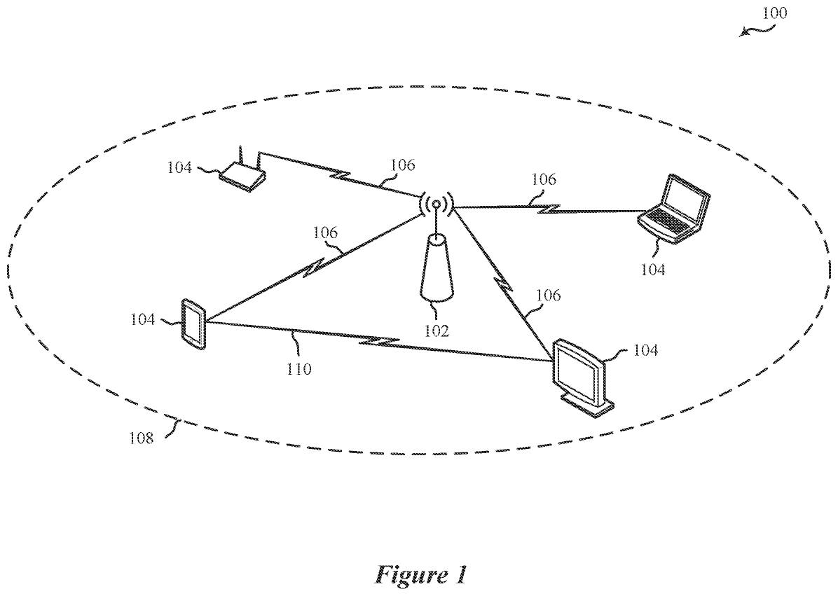

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (Tus) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In some wireless communications environments, Extremely High Throughput (EHT) systems or other systems compliant with future generations of the IEEE 802.11 family of wireless communication protocol standards may provide additional capabilities over other previous systems (for example, High Efficiency (HE) systems or other legacy systems). EHT and newer wireless communication protocols may support flexible operating bandwidth enhancements at APs and STAs, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHz (and each coupled to a different power amplifier). In some other examples, signals for transmission may be generated by four or more different transmit chains of the device, each having a bandwidth of 80 MHz.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHz. In some other examples, the 240 MHz/160+80 MHz bandwidth modes may also be formed by puncturing 320/160+160 MHz bandwidth modes with one or more 80 MHz subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHz band or noncontiguous and located in different bands (such as partly in the 5 GHz band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

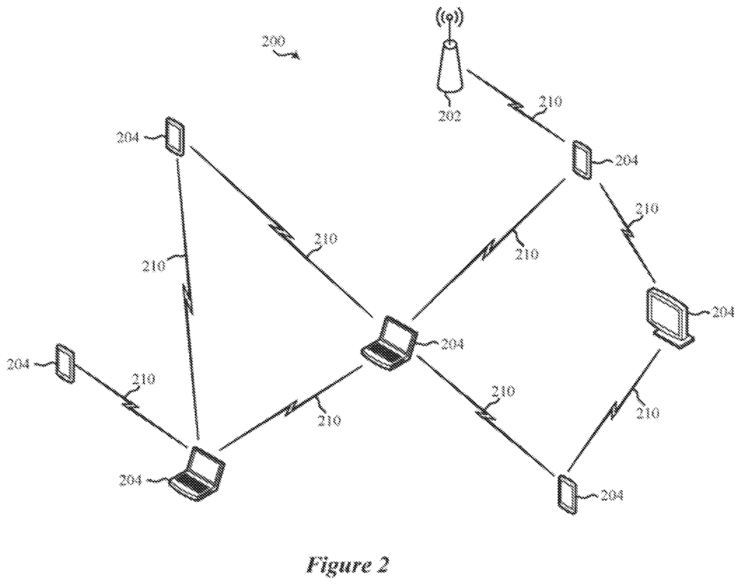

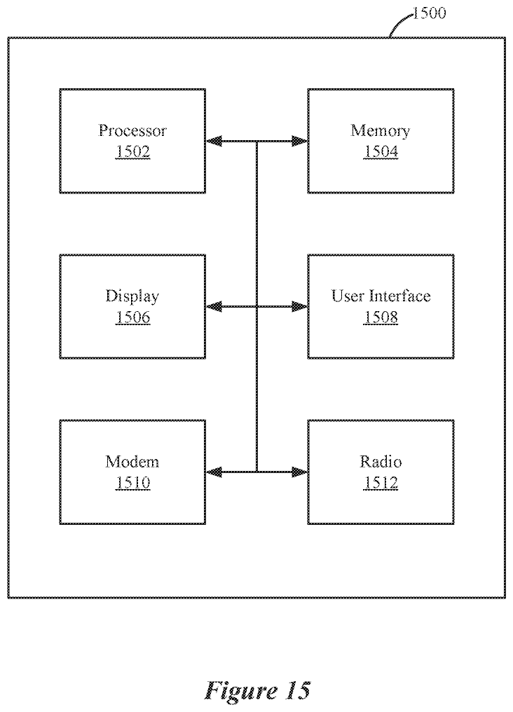

FIG. 2 shows a pictorial diagram of another example wireless communication network 200. According to some aspects, the wireless communication network 200 can be an example of a WLAN. For example, the wireless communication network 200 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The wireless communication network 200 may include multiple STAs 204. As described above, each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities. Wireless communication device 1500 described herein with reference to FIG. 15 may be an example of a STA 204.

The wireless communication network 200 is an example of a peer-to-peer (P2P), ad hoc, or mesh network. STAs 204 can communicate directly with each other via P2P wireless links 210 (without the use of an intermediary AP). In some examples, the wireless communication network 200 is an example of a Neighbor Aware Networking (NAN) network operating in accordance with the Wi-Fi Alliance (WFA) Neighbor Aware Networking standard specification. NAN-compliant STAs 204 (or simply “NAN devices 204”) transmit and receive NAN communications, for example, in the form of Wi-Fi packets including frames conforming to at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). These communications may be transmitted to another NAN device 204 and/or received from another NAN device via wireless P2P links 210 (also referred to as NAN links 210) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 204 in the network automatically establish an ad-hoc network with other NAN devices 204 such that network connectivity can be maintained. Each NAN device 204 is configured to relay data for the NAN network such that various NAN devices 204 may cooperate in the distribution of data within the network. As a result, a message can be transmitted from a source NAN device to a destination NAN device by being propagated along a path, hopping from one NAN device to the next until the destination is reached.

Each NAN device 204 is configured to transmit two types of beacons: NAN discovery beacons and NAN synchronization beacons. When a NAN device 204 is turned on, or otherwise when NAN-functionality is enabled, the NAN device periodically transmits NAN discovery beacons (for example, every 100 Tus, every 128 Tus or another suitable period) and NAN synchronization beacons (for example, every 512 Tus or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices 204 passively scan for discovery beacons from other NAN devices, typically in particular channels (such as channel 6 (2.437 GHz) in the 2.4 GHz band, channel 44 (5.220 GHz) in the 5 GHz lower band (5.150-5.250 GHz), channel 149 (5.745 GHz) in the 5 GHz upper band (5.725-5.825 GHz), and channel 149 if both 5 GHz upper and lower bands are allowed).

When two NAN devices 204 come within a transmission range of one another, they will discover each other based on such discovery beacons. Respective master preference values determine which of the NAN devices 204 will become the master device. If a NAN cluster is not discovered, a NAN device 204 may start a new NAN cluster. When a NAN device 204 starts a NAN cluster, it assumes the master role and broadcasts a discovery beacon. Additionally, a NAN device may choose to participate in more than one NAN cluster within a NAN network.

The links between the NAN devices 204 in a NAN cluster are associated with discovery windows—the times and channel on which the NAN devices converge. At the beginning of each discovery window, one or more NAN devices 204 may transmit a NAN synchronization beacon, which is a management frame used to synchronize the timing of the NAN devices within the NAN cluster to that of the master device. The NAN devices 204 may then transmit multicast or unicast NAN service discovery frames directly to other NAN devices within the service discovery threshold and in the same NAN cluster during the discovery window. The service discovery frames indicate services supported by the respective NAN devices 204.

Some NAN devices 204 also may be configured for wireless communication with other networks such as with a Wi-Fi WLAN or a wireless (for example, cellular) wide area network (WWAN), which may, in turn, provide access to external networks including the Internet. For example, a NAN device 204 may be configured to associate and communicate, via a Wi-Fi or cellular link, with an AP or base station 202 of a WLAN or WWAN network, respectively. In such instances, the NAN device 204 may include software-enabled access point (SoftAP) functionality enabling the STA to operate as a Wi-Fi hotspot to provide other NAN devices 204 with access to the external networks via the associated WLAN or WWAN backhaul. Such a NAN device 204 (referred to as a NAN concurrent device) is capable of operating in both a NAN network as well as another type of wireless network, such as a Wi-Fi BSS. In some such implementations, a NAN device 204 may, in a service discovery frame, advertise an ability to provide such access point services to other NAN devices 204.

There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN Data Link (NDL), also known as a NAN device link, refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber, and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

Each NDL is associated with a respective NDL schedule which indicates times at which the CRBs are available for use by the NAN devices. For example, the NDL schedule may identify a set of NAN slots, per Discovery Window interval, during which the NDL is available. A pair of NAN devices may establish a NAN Data Path (NDP) to communicate over an NDL. The address that is used for an NDP is called a NAN Data Interface (NDI) address. An NDP is a data connection between one or more NDIs of a transmitting NAN device and one or more NDIs of a receiving NAN device. Once an NDP is established, each NAN device participating in the NDP is to be available for data communications during the times indicated by the NDL schedule. For example, if the NDL schedule associated with an NDP indicates that the first four NAN slots of a Discovery Window interval can be used for data communications between a pair of NAN devices, each of the NAN devices are to be available to transmit or receive data over the NDL during the first four NAN slots of each DW interval.

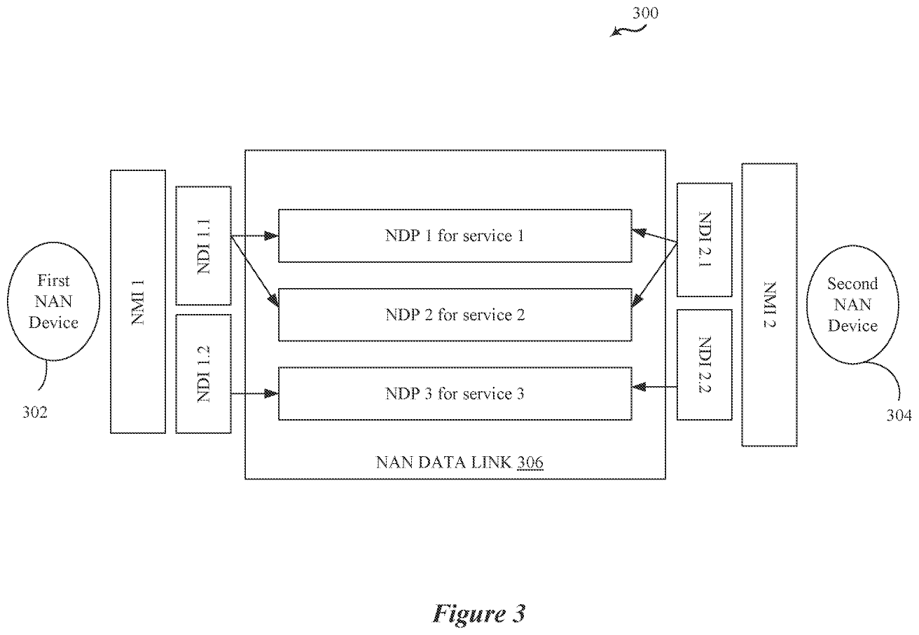

FIG. 3 shows example NAN communications 300 between two NAN devices. The first NAN device 302 and the second NAN device 304 may each be an STA, such as one of STAs 204 described above with reference to FIG. 2.

The first NAN device 302 and the second NAN device 304 are each associated with an NDL 306. An established NDL, such as NDL 306, may be used for multiple services (such as service 1, service 2, and service 3) between the two NAN devices 302 and 304. Different services may have different requirements like security and addresses. As such, specific NDPs may be configured for different services. In the example of FIG. 3, NDP1, NDP2, and NDP3 are associated with service 1, service 2, and service 3, respectively.

As set forth in the WFA NAN standard specifications, a NAN device may use the same NDI for different NDPs, or a NAN device may use different NDIs for different respective NDPs. In the example of FIG. 3, each of NDI 1.1 of the first NAN device 302 and NDI 2.1 of the second NAN device 304 is an address used for both NDP 1 (service 1) and NDP 2 (service 2). NDI 1.2 of the first NAN device 302 and NDI 2.2 of the second NAN device 302 are addresses used for only NDP 3 (service 3).

Each NAN device 302 and 304 may have a respective NAN Management Interface Address (NMI) associated therewith. The NMIs may be used for discovery before setting up the NDPs. Each of the NMIs and the NDIs may be locally managed and is not required to be globally unique. An NMI may be the same as an NDI. The NDL, such as the NDL 306, may be uniquely identified by the NMIs of the NAN devices that established the NDL.

A transmitting NAN device, such as the first NAN device 302, may use the NMI or the NDI of the first NAN device 302 as the transmitter address (TA) for all management frames it sends within a NAN cluster. The first NAN device 302 may use the NMI or the NDI of the intended recipient NAN device, such as the second NAN device 304, as the receiver address (RA) for all unicast management frames the first NAN device 302 sends within the NAN cluster. The NAN device 302 may alternately use a broadcast address as the receiver address (RA) for management frames destined for multiple NAN devices within a NAN cluster. In the example of FIG. 3, NMI 1 is associated with the first NAN device 302 (the transmitter in this instance) and NMI 2 is associated with the second NAN device 304 (the receiver in this instance).

The current WFA standard NAN specifications do not provide for communication between two NAN devices (such as NAN devices 302 and 304) over two or more NDLs simultaneously. Further, while an NDL may have multiple NDPs, each NDP of an NDL is associated with the same physical layer (PHY) mode, bandwidth, and channel or set of channels. Because of these constraints, two NAN devices operating in accordance with the existing WFA NAN specifications are limited to communicating with each other over a single channel or set of channels at a given time. This is so even where these NAN devices are capable of supporting concurrent wireless communications over multiple sets of non-overlapping frequency channels.

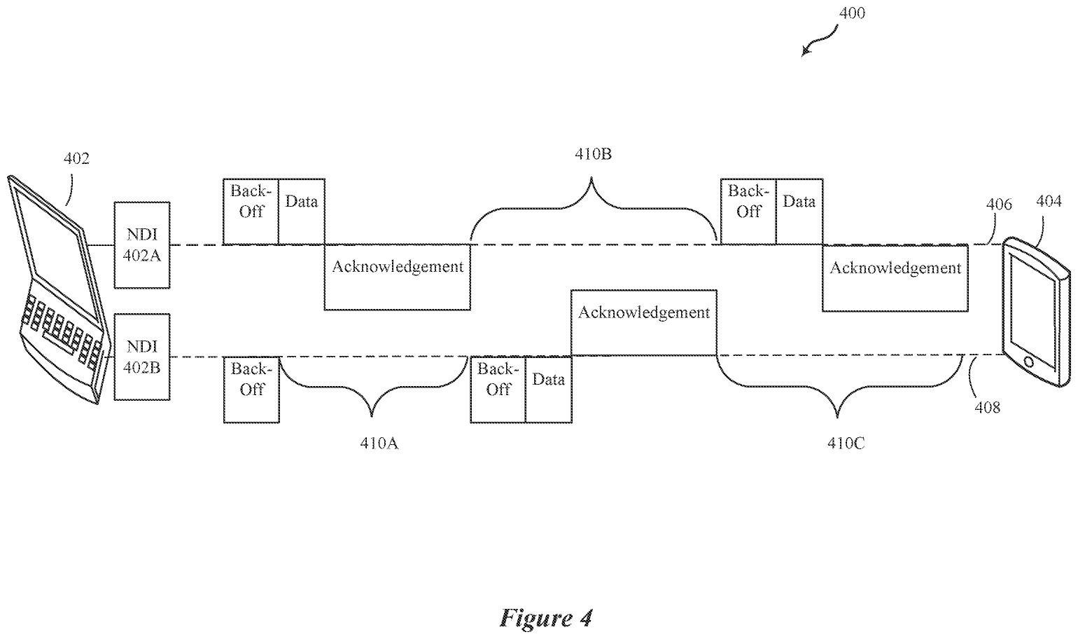

FIG. 4 shows an NDL 400 between a first NAN device 402 and a second NAN device 404. The NDL 400 has two NDPs 406 and 408. NDP 406 is associated with a first NDI 402A of the first NAN device 402 and NDP 408 is associated with a second NDI 402B of the first NAN device 402. As can be seen, while data is being transmitted and/or received between the first NAN device 402 and the second NAN device 404 over the two NDPs 406 and 408, the communication over the two NDPs 406 and 408 is not simultaneous. This is because, under the current WFA standard NAN specifications, each NDP 406 and 408 is associated with the same maximum supported PHY mode, bandwidth, and channel or set of channels (for example, both NDPs 406 and 408 may be associated with channel 155 in the 5 GHz band). Therefore, NDP 408 is idle or unused while data is transmitted on NDP 406, and NDP 406 is idle or unused while data is transmitted on NDP 408. Specifically, in the example of FIG. 4, NDP 406 is idle or unused during segment 410B while data is communicated over NDP 408, and NDP 408 is idle or unused during segment 410A and segment 410C while data is communicated over NDP 406.

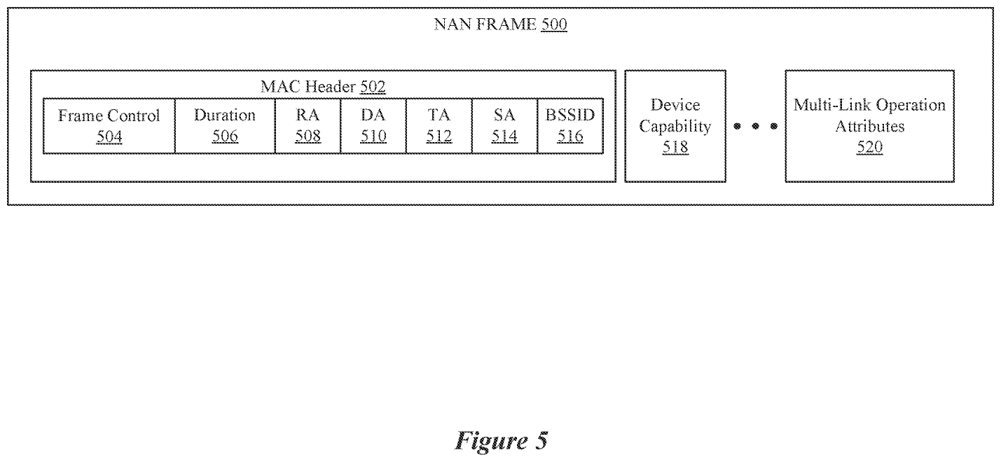

FIG. 5 shows an example NAN frame 500 usable for communications between NAN devices, according to some aspects. The NAN devices may be STAs 204 described above with reference to FIG. 2. The NAN frame 500 may be a management frame, control frame, or other suitable frame. In some examples, the NAN frame 500 is a discovery beacon or a synchronization beacon, a service discovery frame, or other appropriate NAN frame. For ease of explanation, some information elements of the NAN frame 500 may also be referred to as a “field,” a “subfield,” an “element,” or a “subelement,” which may be considered interchangeable terms for purposes of discussion herein.

The NAN frame 500 may have at least a conventional Media Access Control (MAC) header 502, a Device Capability field 518, and a Multi-link Operation Attributes field 520. In some examples, such as when the NAN frame 500 is a service discovery frame, the NAN frame 500 may further include at least a NAN Availability Attributes field.

The MAC header 502 may include a Frame Control field 504, a Duration field 506, a Receiver Address (RA) field 508, a Destination Address (DA) field 510, a Transmitting Address (TA) field 512, a Source Address (SA) field, and a BSSID field 516. In line with WFA standard NAN specifications, the Frame Control field 504 and the Duration field 506 may each be two octets in length, and the RA field 508, the DA field 510, the TA field 512, the SA field 514, and the BSSID field 516 may each be six octets in length. The Device Capability field 518, in accordance with the WFA standard NAN specifications, may have a variable length. In some examples, a length of the Multi-link Operation Attributes field 520 may be variable. The Multi-link Operation Attributes field 520 may also be referred to herein as the MLO information element 520, the MLO IE 520, or the MLO attribute 520.

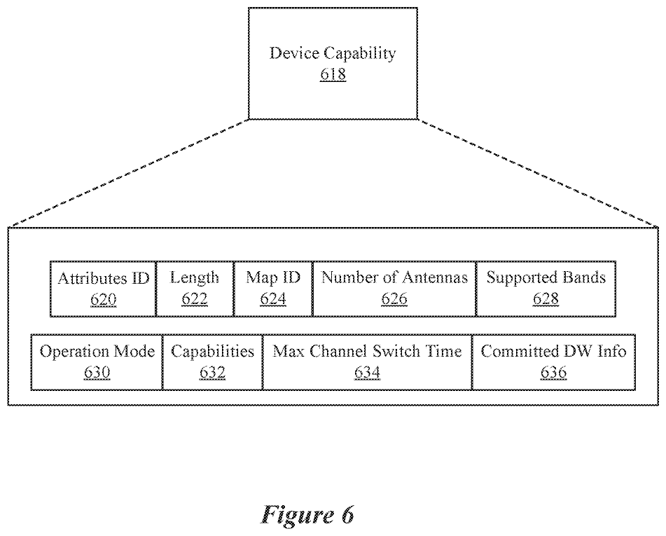

FIG. 6 shows a Device Capability information element 618 of an example NAN frame. The Device Capability information element 618 may be an example of the Device Capability information element 518 of the NAN frame 500 of FIG. 5. The Device Capability information element 618 may have an Attributes ID field 620, a Length field 622, a Map ID field 624, a Number of Antennas field 626, a Supported Bands field 628, an Operations Mode field 630, a Capabilities field 632, a Max Channel Switch Time field 634, and a Committed DW Info field 636.

The Attributes ID field 620 may be one octet in length and may identify the type of NAN attribute. The Length field 622 may be two octets in length and may indicate the length of the following fields. The Map ID field 624 may be one octet in length and may be associated with a NAN Availability map. The Number of Antennas field 626 may be one octet in length and may outline the number of receiving and transmitting antennas. The Supported Bands field 628 may be one octet in length and may indicate supported frequency bands. The Operation Mode field 630 may be one octet in length and may indicate the maximum supported PHY mode and associated bandwidth (such as VHT (very high throughput) support, VHT 80+80 MHz support, VHT 160 MHz support, or EHT 320 MHz (or subsequent generation) support). The Capabilities field 632 field may be one octet in length and may indicate whether the device is a master device. The Max Channel Switch Time field 634 may be two octets in length and may indicate the maximum channel switch time in microseconds. And the Committed DW Info field 636 may be two octets in length and may indicate whether the device is to wake up for discovery windows in a particular frequency band. In some examples, one or more of these fields 620-636 may include additional or different information.

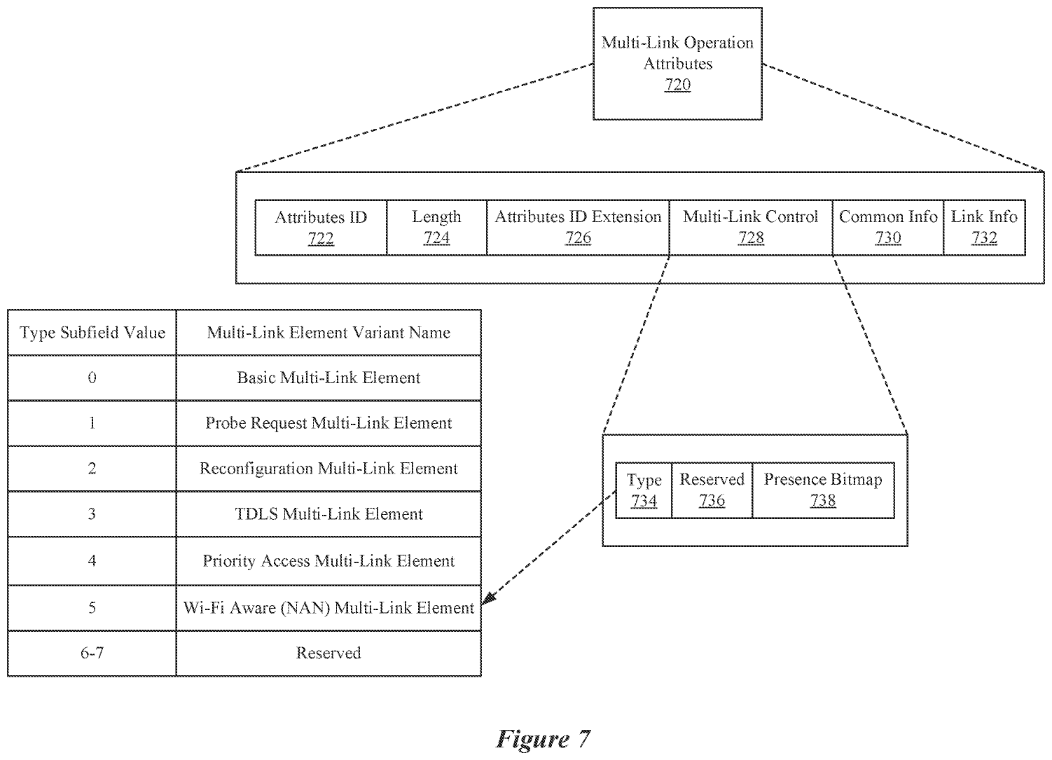

FIG. 7 shows an MLO IE 720 of an example NAN frame. The MLO IE 720 may be an example of the MLO IE 520 of the NAN frame 500 shown in FIG. 5. The MLO IE 720 may include a plurality of fields, including: an Attributes ID field 722, a Length field 724, an Attributes ID Extension field 726, a Multi-link Control field 728, a Common Info field 730, and a Link Info field 732.

In some examples, the Attributes ID field 722, the Length field 724, and the Attributes ID Extension field 726 may each be one octet in length. The Attributes ID field 722 and the Attributes ID Extension field 726 may be part of the profile of the device transmitting the NAN frame that includes the MLO IE 720. The Common Info field 730 may have a variable length and may carry information common to all NDLs. The Link Info field 732 may have a variable length and may carry information specific to the NDLs.

The Multi-link Control field 728 may be two octets in length, and may include a Type subfield 734, a Reserved subfield 736, and a Presence Bitmap subfield 738. The Presence Bitmap subfield 738 may be 11 bits and may be used to indicate the presence of various subfields in the Common Info field 730. The Reserved subfield 736 may be one bit. And the Type subfield 734 may, in some examples, be three bits.

In some examples, the Type subfield 734 is used to differentiate variants of the Multi-link Operation Attributes information element 720. Different variants of a Multi-Link Operation Attributes information element, such as an MLO Attributes IE defined for Extremely High Throughput (EHT) operation in IEEE 802.11be or defined for operation in a subsequent generation of the IEEE 802.11 family of wireless communication protocol standards, may be used for different multi-link operations. In some examples, a Type subfield 734 having a value of zero, one, two, three, or four, respectively indicates that that the Multi-Link Operation Attributes information element 720 is a basic multi-link element, a probe request multi-link element, a reconfiguration multi-link element, a Tunneled Direct Link Setup (TDLS) multi-link element, or a priority access multi-link element. Values six and seven of the Type subfield 734 may be reserved.

In some examples, the Type subfield 734 having a value of five (5) indicates the Multi-Link Operation Attribute information element 720 is a NAN (that is, a Wi-Fi Aware) multi-link element. A value of five of the Type subfield 734 of the MLO Attributes IE 720 of a NAN frame may therefore indicate to the NAN device receiving the NAN frame that the NAN device transmitting the NAN frame is capable of simultaneous multi-NDL operation.

In some examples, the MLO information element 720 of a NAN frame, such as the Type subfield 734 of the MLO information element 720, is associated with a Device Capability information element of the NAN frame. For example, a NAN device may set a value of five for the Type subfield 734 of the MLO information element 720 of a NAN frame in cases in which the Device Capability information element of the NAN frame indicates that the NAN device is capable of supporting MLO. For instance, the NAN device 204 may set a value of five for the Type subfield 734 of the MLO information element 720 in cases in which the Operation Mode subfield 630 of the Device Capability information element 618 of the NAN frame indicates that the NAN device 204 is capable of supporting 802.11be PHY mode and EHT bandwidths (and/or is capable of supporting a subsequent generation of the 802.11 family of standards having an MLO feature).

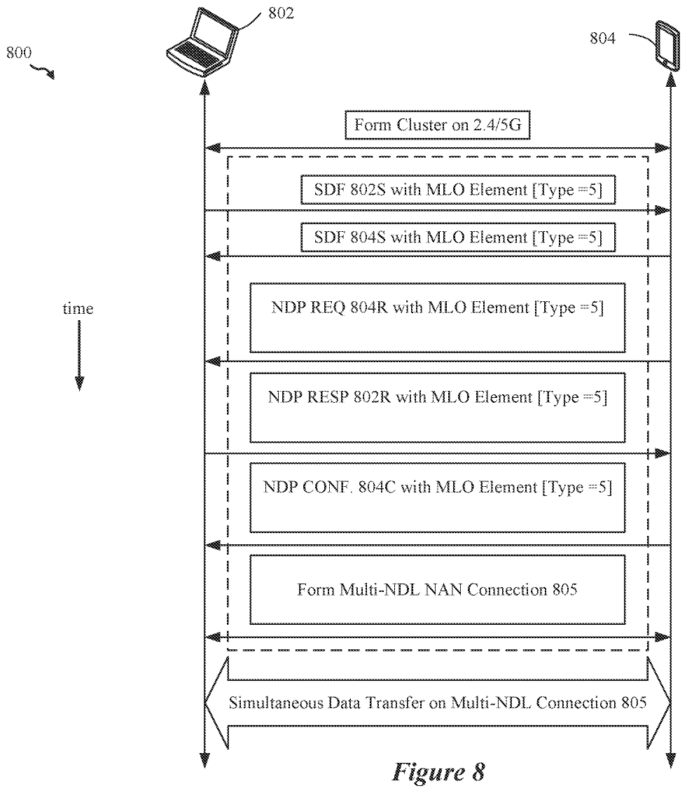

FIG. 8 shows a sequence diagram depicting NAN communications 800 for setting up a multi-NDL connection, according to some aspects. In the example of FIG. 8, a first NAN device 802 and/or a second NAN device 804 may form a multi-NDL connection and the devices 802 and 804 may communicate over the multiple NDLs at least partially simultaneously. The first and second NAN devices 802 and 804 may be, for example, STAs 204 described above with reference to FIG. 2.

Initially, the first NAN device 802 and/or the second NAN device 804 form or join a cluster that subsequently includes each of the first NAN device 802 and the second NAN device 804. The first NAN device 802 may then generate a NAN service discovery frame (SDF) 802S. In examples in which the first NAN device 802 supports MLO for NAN communications, the first NAN device 802 may set the value of the Type subfield of the MLO IE of the NAN SDF 802S to five. The first NAN device 802 may transmit the NAN SDF 802S to the second NAN device 804. The Type subfield value of five of the MLO IE of the NAN SDF 802 may indicate to the second NAN device 804 that the first NAN device 802 supports multi-NDL operation.

The second NAN device 804 may also generate a NAN SDF 804S. In examples in which the second NAN device 804 also supports MLO for NAN communications, the second NAN device 804 may also set the value of the Type subfield of the MLO IE of the NAN SDF 804S to five. The second NAN device 804 may then transmit the NAN SDF 804S to the first NAN device 802. The Type subfield value of five of the MLO IE of the NAN SDF 804S may indicate to the first NAN device 802 that the second NAN device 804 supports multi-NDL operation.

In some examples, the second NAN device 804 may generate a NAN Data Path request message 804R and transmit it to the first NAN device 802. The NAN Data Path request message 804R may include an MLO IE having a Type subfield with a value set to five, which may indicate to the first NAN device 802 that the second NAN device 804 supports multi-NDL operation. In some examples, the NAN Data Path request message 804R includes the NMI address associated with the second NAN device 804, together with the NDI profile of at least two NDIs associated with the second NAN device 804. The NMI address may be an MLD MAC address of the second NAN device 804. Each of the NDI profiles may include an NDI MAC address and other relevant data associated with that NDI usable in the establishment of an NDL, such as a frequency band, a bandwidth, a PHY mode, a regulatory class, and an NDP slot bit-map per NDI.

Upon receipt of the NAN Data Path request message 804R, the first NAN device 802 may generate a NAN Data Path response message 802R. The NAN Data Path response message 802R may include an MLO IE having a Type subfield with a value set to five, which may indicate to the second NAN device 804 that the first NAN device 802 supports multi-NDL operation. In some examples, the NAN Data Path response message 802R includes the NMI address associated with the first NAN device 802, together with the NDI profile of at least two NDIs associated with the first NAN device 802. The NMI address may be an MLD MAC address of the first NAN device 802. Each of the NDI profiles may include an NDI MAC address and other relevant data associated with that NDI usable in the establishment of an NDL, such as a frequency band, a bandwidth, a PHY mode, a regulatory class, and an NDP slot bit-map per NDI.

The second NAN device 804, upon receipt of the NAN Data Path response message 802R, may generate and transmit a NAN Data Path confirmation message 804C to the first NAN device 802. The NAN Data Path confirmation message may include an MLO IE having a Type subfield with a value set to five, which may indicate to the first NAN device 802 that the second NAN device 804 supports multi-NDL operation. In some examples, the confirmation message 804C may include a discovery window and additional availability slots associated with each NDL. The first NAN device 802 and/or the second NAN device 804 may, in view of the information communicated in the NAN Data Path response message 804R, the NAN Data Path request message 802R, and/or the NAN Data Path confirmation message 804C, form a multi-NDL connection 805. The multi-NDL connection 805 includes two or more NDLs, and each of the NDLs may be associated with a frequency channel or set of frequency channels that do not overlap the frequency channel(s) associated with another of the NDLs. The first NAN device 802 and the second NAN device 804 may therefore be able to communicate via the multiple NDLs of the NDL connection 805 concurrently. Associating each NDL of the multi-NDL connection 805 with non-overlapping frequency channels may enable increased throughput (relative to using two NDPs associated with the same set of frequency channels or relative to using a single NDL at a time), reduce latency, and result in power savings for the devices 802 and 804. These benefits may thus enhance user experience when using NAN.

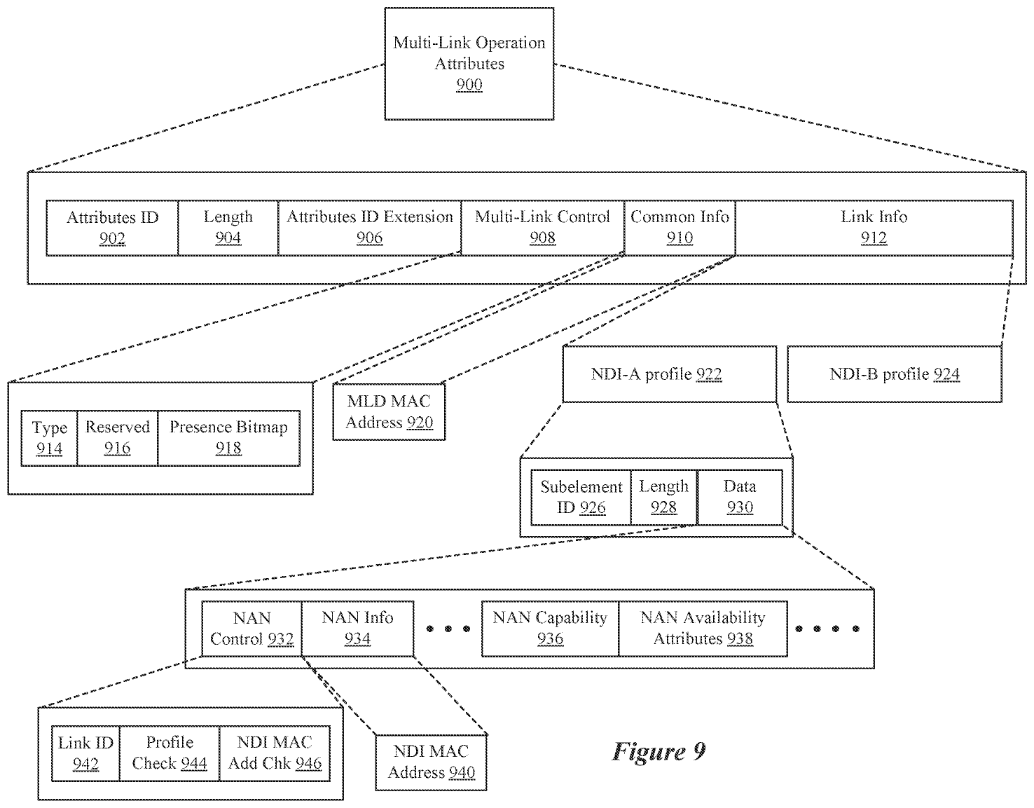

FIG. 9 shows a Multi-link Operation information element 900 of an example request message, according to some aspects. For example, the MLO IE 900 may be part of the request message 804R discussed above with reference to FIG. 8. The MLO IE 900 includes a plurality of fields, including: an Attributes ID field 902, a Length field 904, an Attributes ID Extension field 906, a Multi-link Control field 908, a Common Info field 910, and a Link Info field 912. The Attributes ID field 902, the Length field 904, and the Attributes ID Extension field 906 may each be one octet in length. The Attributes ID field 902 and the Attributes ID Extension field 906 may be part of the profile of the NAN device 804 transmitting the request message 804R.

The Multi-link Control field 908 may have a Type subfield 914, a Reserved subfield 916, and a Presence Bitmap subfield 918. As discussed above for the Multi-Link Control field 728 of MLO IE 720 described with reference to FIG. 7, a value of five of the Type subfield 914 may indicate that the second NAN device 804 supports MLO for NAN communications.

The Common Info field 910, in some examples, includes the NMI, which is the MLD MAC address 920 of the device associated with the request message, such as the MLD MAC address of the second NAN device 804. The Link Info field 912 may include the per-NDI profile of two or more NDIs associated with the NAN device, such as profile 922 of NDI-A and profile 924 of NDI-B each associated with the second NAN device 804.

Each NDI profile may include a Subelement ID field, a Length field, and a Data field. For example, the NDI-A profile 922 includes a Subelement ID field 926, a Length field 928, and a Data field 930. The NDI-B profile 924 may include like fields associated with the NDI-B profile 924.

The Data field 930 may include at least a NAN Control field 932, a NAN Info field 934, a NAN Capability field 936, and a NAN Availability Attributes field 938. The NAN Control field 932 may in-turn include a Link ID field 942, a Profile Check field 944, and an NDI MAC Address Check field 946. The Link ID field 42 may carry an identification number identifying the NDL associated with NDI-A. The Profile Check field 944 may be set to one in examples in which the NDI Profile (such as NDI-A profile 922) is complete. The NAN Info field 934, in some examples, includes the NDI MAC address, such as the NDI MAC address 940 of NDI-A. The NDI MAC Address Check field 946 of the NAN Control field 932 may be set to one in examples in which the NDI MAC Address is present in the NAN Info field (such as when NDI MAC Address 940 is present in NAN Info field 934).

The NAN Capability field 936, in some examples, indicates the operating parameters of the NAN device 804, such as the frequency band, the PHY mode, bandwidth, channel, and regulatory class. The NAN Availability Attributes field 938 may indicate at least the committed and potential availability of the NAN device 804 for participating in NAN communications. The NDI-B profile 924 may include like fields associated with NDI-B. The MLO IE of the response message 802R (see FIG. 8) generated by the first NAN device 802 and transmitted to the second NAN device 804 may have the same general format as the MLO IE 900 of the request message 804R discussed above, and may in turn provide to the second NAN device 804 like information associated with the first NAN device 802. In some examples, the confirmation message, such as the conformation message 804C, indicates the discovery window and further availability window allocated to each NDL. The request message 804R, the response message 802R, and the confirmation message 804C, including the respective MLO IEs thereof, may collectively allow for or facilitate the establishment of the multi-NDL connection 805 between the two NAN devices 802 and 804.

The example NAN communications 800 in FIG. 8 between NAN devices 802 and 804 illustrate that MLO IEs are initially included in SDFs 802S and 804S that are generated after a cluster that includes the NAN devices 802 and 804 has been formed. In other examples, a NAN device may include an MLO IE in a beacon that is transmitted to another NAN device prior to the formation of a cluster that includes these NAN devices. For instance, the NAN device 802 may indicate its capability to support multi-NDL operation to the NAN device 804 prior to formation of a cluster that includes the NAN devices 802 and 804.

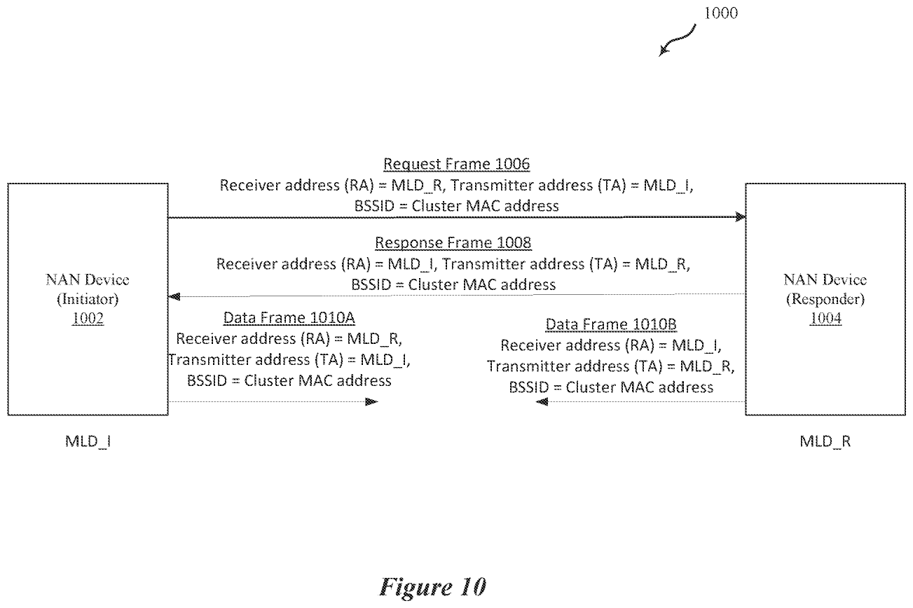

FIG. 10 shows example NAN communications 1000 including a request frame 1006, a response frame 1008, and data frames 1010A and 1010B, according to some aspects. In this example, a NAN device 1002 transmits the request frame 1006 to the NAN device 1004, and the NAN device 1004 transmits the response frame 1008 to the NAN device 1002 in response to the request frame 1006. The NAN device 1002 may also be referred to as the Initiator device 1002 and the NAN device 1004 may also be referred to as the Responder device 1004.

The Initiator device 1002 may have an MLD MAC address MLD_I, which may be the NMI of the Initiator device 1002. The Responder device 1004 may have an MLD MAC address MLD_R, which may be the NMI of the Responder device 1004.

The request frame 1006 transmitted by the Initiator device 1002 to the Responder device 1004 may include at least a RA field, a TA field, and a BSSID field. The RA field of the request frame 1006 may include the MLD MAC address MLD_R of the Responder device 1004, the TA field may include the MLD MAC address MLD_I of the Initiator device 1002, and the BSSID may include the cluster MAC address.

The response frame 1008 transmitted by the Responder device 1004 to the Initiator device 1002 may include at least an RA field, a TA field, and a BSSID field. The RA field in the response frame 1008 may include the MLD MAC address MLD_I of the Initiator device 1002, the TA field may include the MLD MAC address MLD_R of the Responder device 1004, and the BSSID field may include the cluster MAC address.

Data frame 1010A transmitted by the Initiator device 1002 to the Responder device 1004 may include the MLD MAC address MLD_R in the RA field, the MLD MAC address MLD_I in the TA field, and the cluster MAC address in the BSSID field. Similarly, data frame 1010B transmitted by the Responder device 1004 to the Initiator device 1002 may include the MLD MAC address MLD_I in the RA field, the MLD MAC address MLD_R in the TA field, and the cluster MAC address in the BSSID field.

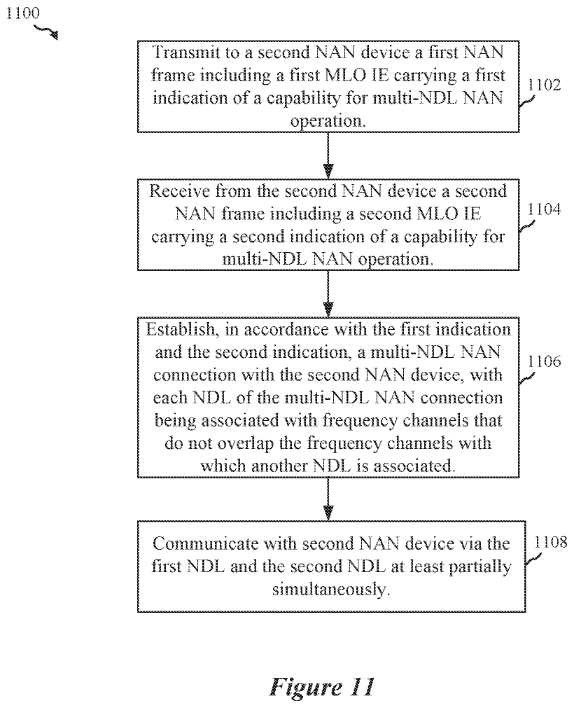

FIG. 11 shows a flowchart illustrating an example process 1100 for forming a multi-NDL connection and communicating at least partially concurrently over the multiple NDLs, according to some aspects.

At block 1102, a first NAN device transmits to a second NAN device a first NAN frame that includes a first MLO IE carrying a first indication of a capability of the first NAN device for multi-NDL operation. The first NAN device may be the NAN device 802 or another suitable NAN device, and the second NAN device may be the NAN device 804 or another suitable NAN device. At block 1104, the first NAN device receives from the second NAN device a second NAN frame that includes a second MLO IE carrying a second indication of a capability of the second NAN device for multi-NDL operation. At block 1106, the first NAN device establishes, in accordance with the first indication and the second indication, a multi-NDL connection with the second NAN device. The multi-NDL connection includes a first NDL associated with a first set of frequency channels and a second NDL associated with a second set of frequency channels non-overlapping the first set of frequency channels. At block 1108, the first NAN device communicates with the second NAN device via the first NDL and the second NDL at least partially simultaneously.

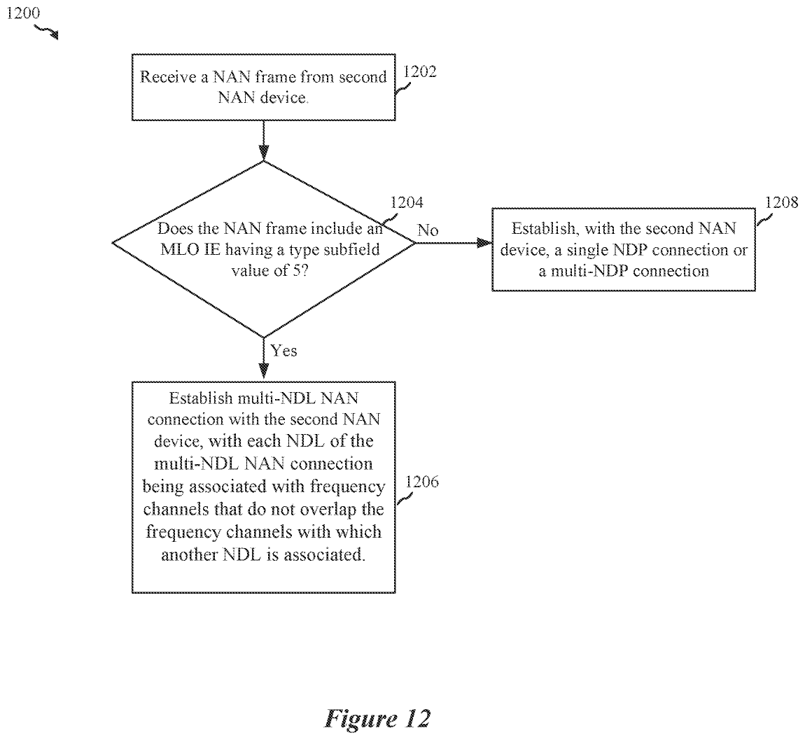

FIG. 12 shows a flowchart illustrating a process 1200 for forming a multi-NDL connection, according to some aspects. At block 1202, a first NAN device receives a NAN frame from a second NAN device. The first and second NAN devices may respectively be examples of NAN devices 802 and 804. The NAN frame may be a beacon, a service discovery frame, or other suitable NAN frame. In some examples, the NAN frame may be an example of the NAN frame 500 shown in FIG. 5. At block 1204, the first NAN device identifies the value of the Type subfield of the MLO IE of the NAN frame. If the value of Type subfield of the MLO IE is five, then at block 1206 the first NAN device establishes a multi-NDL connection with the second NAN device. The multi-NDL connection includes two (or more) NDLs, and each NDL is associated with a set of one or more frequency channels that do not overlap the sets of frequency channels associated with another of the NDLs of the multi-NDL connection.

Conversely, if the value of the Type subfield of the MLO IE of the NAN frame identified by the first NAN device at step 1204 is a value other than five, or if the NAN frame does not include an MLO IE, then at block 1208 the first NAN device establishes a single NDP connection or a multi-NDP connection with the second NAN device. If the connection formed at block 1208 is a multi-NDP connection, each NDP thereof may be associated with the same set of frequency channels.

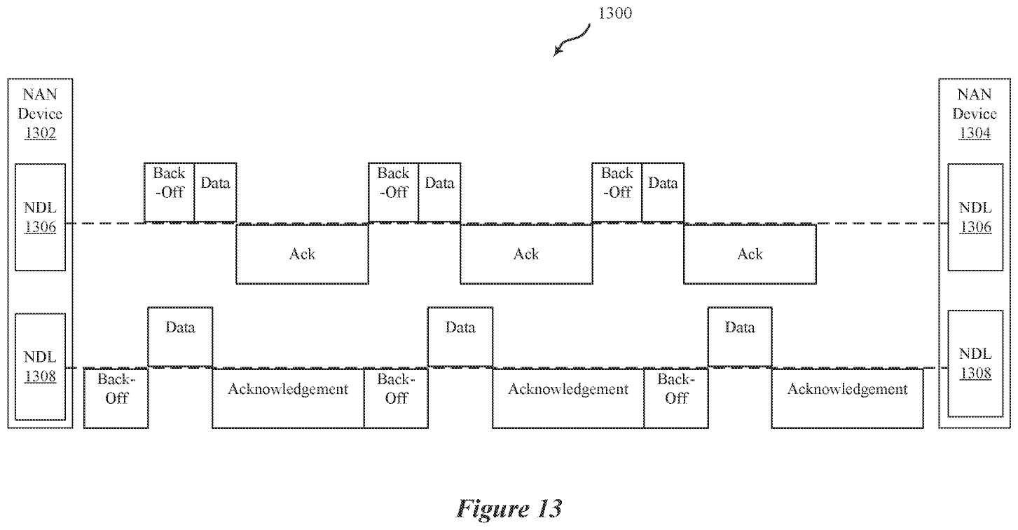

FIG. 13 shows an example multi-NDL connection 1300 between a first NAN device 1302 and a second NAN device 1304. The first NAN device 1302 may be an example of NAN device 802 and the second NAN device 1304 may be an example of NAN device 804 each described with reference to FIG. 8. The multi-NDL connection 1300 may be an example of the multi-NDL connection 805 described with reference to FIG. 8.

The multi-NDL connection 1300 includes a first NDL 1306 and a second NDL 1308. Each of the first NDL 1306 and the second NDL 1308 allows for data communication between the first NAN device 1302 and the second NAN device 1304. Further, each of the NDL 1306 and NDL 1308 is associated with a unique and non-overlapping set of frequency channels. Data may thus be transmitted and/or received by the NAN devices 1302 and 1304 over the NDLs 1306 and 1308 concurrently. FIG. 13 shows data being communicated over the NDLs 1306 and 1308 concurrently. As is evident from FIG. 13, in some examples, a start time of a data communication on one NDL (such as NDL 1306) is not required to be synchronized with an end time (or a start time) of a data communication on another NDL (such as NDL 1308).

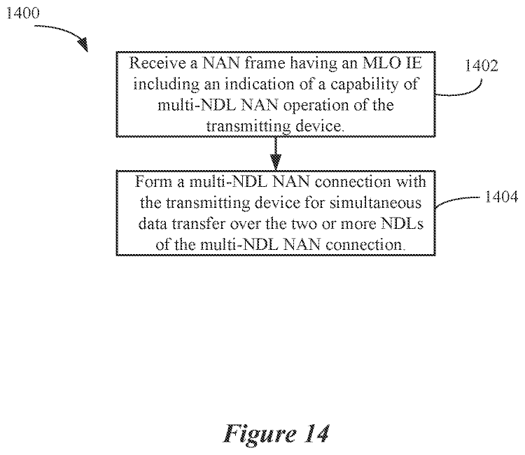

FIG. 14 shows a flowchart illustrating an example process 1400 performable at a wireless STA that supports MLO for NAN communications, according to some aspects of the present disclosure. The operations of the process 1400 may be implemented by a wireless STA or its components as described herein. For example, the process 1400 may be performed by a wireless communication device, such as the wireless communication device 1500 described with reference to FIG. 15, operating as or within a wireless STA. In some examples, the process 1400 may be performed by a wireless STA such as one of the STAs 104,204, and 804 described with reference to FIGS. 1,2, and 8, respectively.

In some examples, in block 1402, the wireless STA receives a NAN frame having an MLO IE including an indication of a capability of multi-NDL operation of the transmitting device. In block 1404, the wireless STA forms a multi-NDL connection with the transmitting device for simultaneous data transfer over the two or more NDLs of the multi-NDL connection.

FIG. 15 shows a block diagram of an example wireless communication device 1500 that supports MLO for NAN communications, according to some aspects of the present disclosure. The wireless communication device 1500 may also be referred to herein as NAN device 1500. In some examples, the wireless communication device 1500 is configured or operable to perform the process 1400 described with reference to FIG. 14. In some examples, the wireless communication device 1500 is configured or operable to perform one or more of the processes 1100, 1200, and 1400 described with reference to FIGS. 11, 12, and 14, respectively.

In various examples, the wireless communication device 1500 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and, one or more memories or memory blocks (collectively “the memory”).

In some examples, the wireless communication device 1500 can be a device for use in a STA, such as STA 104, STA 204, or STA 804 described respectively with reference to FIG. 1, FIG. 2, and FIG. 8. In some other examples, the wireless communication device 1500 can be a STA that includes such a chip, SoC, chipset, package or device as well as multiple antennas. The wireless communication device 1500 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1500 also includes or can be coupled with an application processor which may be further coupled with another memory. In some examples, the wireless communication device 1500 further includes a user interface (UI) (such as a touchscreen or keypad) and a display, which may be integrated with the UI to form a touchscreen display. In some examples, the wireless communication device 1500 may further include one or more sensors such as, for example, one or more inertial sensors, accelerometers, temperature sensors, pressure sensors, or altitude sensors. In some examples, the wireless communication device 1500 may support NAN networks, including multi-NDL communications.

The wireless communication device 1500 includes one or more processors, processing blocks, or processing elements 1502 (collectively, “the processor 1502”), one or more memory blocks or elements 1504 (collectively, “the memory 1504”), one or more displays 1506 (collectively, “the display 1506”), a user interface 1508 (such as a keypad or a touch screen), one or more modems 1510 (collectively, “the modem 1510”), and one or more radios 1512 (collectively, “the radio 1512”). Portions of one or more of the components 1502, 1504, 1506, 1508, 1510, and 1512 may be implemented at least in part in hardware or firmware. In some examples, at least some of the components of the device 1500 are implemented at least in part by a processor and as software stored in a memory. For example, portions of one or more of the display 1506, the user interface 1508, the modem 1510, and the radio 1512 can be implemented as non-transitory instructions (or “code”) executable by the processor 1502 to perform the functions or operations of the respective module.

In some examples, the processor 1502 may be a component of a processing system. A processing system may generally refer to a system or series of machines or components that receives inputs and processes the inputs to produce a set of outputs (which may be passed to other systems or components of, for example, the device 1500). For example, a processing system of the device 1500 may refer to a system including the various other components or subcomponents of the device 1500, such as the processor 1502, or a transceiver, or a communications manager, or other components or combinations of components of the device 1500. The processing system of the device 1500 may interface with other components of the device 1500, and may process information received from other components (such as inputs or signals) or output information to other components. For example, a chip or modem of the device 1500 may include a processing system, a first interface to output information and a second interface to obtain information. In some examples, the first interface may refer to an interface between the processing system of the chip or modem 1510 and a transmitter, such that the device 1500 may transmit information output from the chip or modem 1510. In some examples, the second interface may refer to an interface between the processing system of the chip or modem 1510 and a receiver, such that the device 1502 may obtain information or signal inputs, and the information may be passed to the processing system. The first interface also may obtain information or signal inputs, and the second interface also may output information or signal outputs.

The processor 1502 is capable of, configured to, or operable to processes information received through the radio 1512 and the modem 1510, and processes information to be output through the modem 1510 and the radio 1512 for transmission through the wireless medium. The processor 1502 may perform logical and arithmetic operations based on program instructions stored within the memory 1504. The instructions in the memory 1504 may be executable (by the processor 1502, for example) to implement the methods described herein. In some examples, the processor 1502, together with the memory 1504, is capable of, configured to, or operable to generate, transmit, and receive NAN frames, such as NAN frames having an MLO IE as described with reference to the NAN frame 500 in FIG. 5, and take an action in accordance with the MLO IE.

The memory 1504 is capable of, configured to, or operable to provide instructions and data to the processor 1502. The user interface 1508 may be any device that allows a user to interact with the wireless communication device 1500, such as a keyboard, a mouse, and a microphone. In aspects, the user interface 1508 may be integrated with the display 1506 to form a touchscreen. The modem 1510 is capable of, configured to, or operable to implement a PHY layer. For example, the modem 1510 is configured to modulate packets and to output the modulated packets to the radio 1512 for transmission over the wireless medium. The modem 1510 is similarly configured to obtain modulated packets received by the radio 1512 and to demodulate the packets to provide demodulated packets.

The radio 1512 includes at least one radio frequency transmitter and at least one radio frequency receiver, which may be combined into one or more transceivers. The transmitter(s) and receiver(s) may be coupled to one or more antennas. In some aspects, the processor 1502, the memory 1504, the modem 1510, and the radio 1512 may collectively facilitate the wireless communication of the wireless communication device 1500 with other wireless communication devices over multiple frequency bands (such as 2.4 GHz, 5 GHz, and/or 6 GHz).

Implementation examples are described in the following numbered clauses:
1. A method for wireless communication by a first neighbor aware networking (NAN) device, the method including:
transmitting, to a second NAN device, a first NAN frame that includes a first multi-link operation (MLO) information element indicating a capability of the first NAN device for concurrent multi-NAN Data Link (NDL) operation;
receiving, from the second NAN device, a second NAN frame that includes a second MLO information element indicating a capability of the second NAN device for concurrent multi-NDL operation;
establishing, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
communicating with the second NAN device via the first NDL and the second NDL at least partially concurrently.
2. The method of clause 1, where the first NAN frame is a service discovery frame or a discovery beacon.
3. The method of clause 1, where the second NAN frame is a service discovery frame or a discovery beacon.
4. The method of clause 1, where:
the first NAN frame includes a device capability information element that includes an operation mode field; and
the MLO information element is associated with the operation mode field.
5. The method of clause 4, where the operation mode field includes a maximum supported bandwidth of the first NAN device.
6. The method of clause 1, further including establishing a NAN cluster including the first NAN device and the second NAN device prior to the transmission of the first NAN frame to the second NAN device.
7. The method of clause 1, where the first MLO information element includes a multi-link control information element that includes a type subfield indicating that the first NAN device supports concurrent multi-NDL operation.
8. The method of clause 1, where the establishment of the multi-NDL connection includes:
receiving, from the second NAN device, a request message that includes a second multi-link device (MLD) MAC address associated with the second NAN device;
transmitting, to the second NAN device, a response message that includes a first MLD MAC address associated with the first NAN device; and
receiving, from the second NAN device, a confirmation message indicating at least a respective discovery window associated with each of the first NDL and the second NDL.
9. The method of clause 8, where the confirmation message further indicates a further availability window associated with at least one of the first NDL or the second NDL.
10. The method of clause 8, where the request message includes a first profile of a first NAN data interface (NDI) and a second profile of a second NDI each associated with the second NAN device.
11. The method of clause 10, where the first profile includes at least a bandwidth associated with the first NDI.
12. The method of clause 8, where the response message includes a first profile of a first NDI and a second profile of a second NDI each associated with the first NAN device.
13. The method of clause 12, where the first profile includes at least a bandwidth associated with the first NDI.
14. A neighbor aware networking (NAN) device, including:
at least one memory; and
at least one processor communicatively coupled with the at least one memory and operable to cause the NAN device to:
   transmit, to a second NAN device, a first NAN frame that includes a first multi-link operation (MLO) information element indicating a capability of the NAN device for concurrent multi-NAN Data Link (NDL) operation;
   receive, from the second NAN device, a second NAN frame that includes a second MLO information element indicating a capability of the second NAN device for concurrent multi-NDL operation;
   establish, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
   communicate with the second NAN device via the first NDL and the second NDL, at least part of the communicating being concurrent via the first NDL and the second NDL.
15. The NAN device of clause 14, where the first NAN frame is a service discovery frame or a discovery beacon.
16. The NAN device of clause 14, where the second NAN frame is a service discovery frame or a discovery beacon.
17. The NAN device of clause 14, where:
the first NAN frame includes a device capability information element that includes an operation mode field; and
the MLO information element is associated with the operation mode field.
18. The NAN device of clause 17, where the operation mode field includes a maximum supported bandwidth of the NAN device.
19. The NAN device of clause 14, where the processor is further operable to cause the NAN device to:
   receive, from the second NAN device, a request message that includes a second multi-link device (MLD) MAC address associated with the second NAN device;
   transmit, to the second NAN device, a response message that includes a first MLD MAC address associated with the NAN device; and
   receive, from the second NAN device, a confirmation message indicating at least a respective discovery window associated with each of the first NDL and the second NDL.
20. The NAN device of clause 19, where the request message includes a first profile of a first NAN data interface (NDI) and a second profile of a second NDI each associated with the second NAN device.
21. The NAN device of clause 20, where the first profile includes at least a bandwidth associated with the first NDI.
22. The NAN device of clause 21, where the response message includes a third profile of a third NDI and a fourth profile of a fourth NDI each associated with the NAN device.
23. The NAN device of clause 22, where the third profile and the fourth profile respectively include at least a bandwidth associated with the third NDI and the fourth NDI.
24. A neighbor aware networking (NAN) device, including:
means for transmitting, to a second NAN device, a first NAN frame that includes a first multi-link operation (MLO) information element carrying an indication of a capability of the NAN device for concurrent multi-NAN Data Link (NDL) operation;
means for receiving, from the second NAN device, a second NAN frame that includes an indication of a capability of the second NAN device for concurrent multi-NDL operation;
means for establishing, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
means for communicating with the second NAN device via the first NDL and the second NDL at least partially concurrently.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communication by a first neighbor aware networking (NAN) device, the method comprising:
transmitting, to a second NAN device, a first NAN frame that includes a first multi-link operation (MLO) information element indicating a capability of the first NAN device for concurrent multi-NAN Data Link (NDL) operation;
receiving, from the second NAN device, a second NAN frame that includes a second MLO information element indicating a capability of the second NAN device for concurrent multi-NDL operation;
establishing, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
communicating with the second NAN device via the first NDL and the second NDL at least partially concurrently.

2. The method of claim 1, wherein the first NAN frame is a service discovery frame or a discovery beacon.

3. The method of claim 1, wherein the second NAN frame is a service discovery frame or a discovery beacon.

4. The method of claim 1, wherein:
the first NAN frame comprises a device capability information element that includes an operation mode field; and
the MLO information element is associated with the operation mode field.

5. The method of claim 4, wherein the operation mode field includes a maximum supported bandwidth of the first NAN device.

6. The method of claim 1, further comprising establishing a NAN cluster comprising the first NAN device and the second NAN device prior to the transmission of the first NAN frame to the second NAN device.

7. The method of claim 1, wherein the first MLO information element comprises a multi-link control information element that includes a type subfield indicating that the first NAN device supports concurrent multi-NDL operation.

8. The method of claim 1, wherein the establishment of the multi-NDL connection comprises:
receiving, from the second NAN device, a request message that includes a second multi-link device (MLD) MAC address associated with the second NAN device;
transmitting, to the second NAN device, a response message that includes a first MLD MAC address associated with the first NAN device; and
receiving, from the second NAN device, a confirmation message indicating at least a respective discovery window associated with each of the first NDL and the second NDL.

9. The method of claim 8, wherein the confirmation message further indicates a further availability window associated with at least one of the first NDL or the second NDL.

10. The method of claim 8, wherein the request message includes a first profile of a first NAN data interface (NDI) and a second profile of a second NDI each associated with the second NAN device.

11. The method of claim 10, wherein the first profile includes at least a bandwidth associated with the first NDI.

12. The method of claim 8, wherein the response message includes a first profile of a first NDI and a second profile of a second NDI each associated with the first NAN device.

13. The method of claim 12, wherein the first profile includes at least a bandwidth associated with the first NDI.

14. A neighbor aware networking (NAN) device, comprising:
at least one memory; and
at least one processor communicatively coupled with the at least one memory and operable to cause the NAN device to:
transmit, to a second NAN device, a first NAN frame that includes a first multi-link operation (MLO) information element indicating a capability of the NAN device for concurrent multi-NAN Data Link (NDL) operation;
receive, from the second NAN device, a second NAN frame that includes a second MLO information element indicating a capability of the second NAN device for concurrent multi-NDL operation;
establish, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
communicate with the second NAN device via the first NDL and the second NDL, at least part of the communicating being concurrent via the first NDL and the second NDL.

15. The NAN device of claim 14, wherein the first NAN frame is a service discovery frame or a discovery beacon.

16. The NAN device of claim 14, wherein the second NAN frame is a service discovery frame or a discovery beacon.

17. The NAN device of claim 14, wherein:
the first NAN frame comprises a device capability information element that includes an operation mode field; and
the MLO information element is associated with the operation mode field.

18. The NAN device of claim 17, wherein the operation mode field includes a maximum supported bandwidth of the NAN device.

19. The NAN device of claim 14, wherein the processor is further operable to cause the NAN device to:
receive, from the second NAN device, a request message that includes a second multi-link device (MLD) MAC address associated with the second NAN device;
transmit, to the second NAN device, a response message that includes a first MLD MAC address associated with the NAN device; and
receive, from the second NAN device, a confirmation message indicating at least a respective discovery window associated with each of the first NDL and the second NDL.

20. The NAN device of claim 19, wherein the request message includes a first profile of a first NAN data interface (NDI) and a second profile of a second NDI each associated with the second NAN device.

21. The NAN device of claim 20, wherein the first profile includes at least a bandwidth associated with the first NDI.

22. The NAN device of claim 21, wherein the response message includes a third profile of a third NDI and a fourth profile of a fourth NDI each associated with the NAN device.

23. The NAN device of claim 22, wherein the third profile and the fourth profile respectively include at least a bandwidth associated with the third NDI and the fourth NDI.

24. A neighbor aware networking (NAN) device, comprising:
means for transmitting, to a second NAN device, a first NAN frame that includes a first multi-link operation (MLO) information element carrying an indication of a capability of the NAN device for concurrent multi-NAN Data Link (NDL) operation;
means for receiving, from the second NAN device, a second NAN frame that includes an indication of a capability of the second NAN device for concurrent multi-NDL operation;
means for establishing, in accordance with the first MLO information element and the second MLO information element, a multi-NDL connection with the second NAN device, the multi-NDL connection including a first NDL associated with a first set of frequency channels and a second NDL associated with a second set of frequency channels non-overlapping the first set of frequency channels; and
means for communicating with the second NAN device via the first NDL and the second NDL at least partially concurrently.
